(19) United States
(12) Patent Application Publication
(10) Pub. No.: US 2011/0202433 A1
(43) Pub. Date: Aug. 18, 2011

(54) LICENSE MANAGEMENT SYSTEM, LICENSE MANAGEMENT METHOD, AND COMPUTER PROGRAM PRODUCT

(76) Inventor: Akira YOKOYAMA, Kanagawa (JP)

(21) Appl. No.: 13/010,270

(22) Filed: Jan. 20, 2011

(30) Foreign Application Priority Data
Feb. 16, 2010 (JP) 2010-031807

(51) Int. Cl. G06Q 10/00; G06Q 30/00

(52) U.S. Cl. 705/28

(57) ABSTRACT

A license management system includes image processing apparatuses and a license management server that rents out licenses to the image processing apparatuses. The license management server includes: a storage unit that stores a purchased license count and a rented-out license count that are associated with type of a program; a first receiving unit that receives a license borrowing request from one of the image processing apparatuses; a rent-out control unit that, if the rented-out license count is equal to or greater than the purchased license count, determines to rent-out a trial-version license to the one image processing apparatus whereas, if not, determines to rent out a formal-version license to the one image processing apparatus; an obtaining unit that obtains license usage status; and a first notification unit that notifies a user of the usage status.

### CROSS-REFERENCE TO RELATED APPLICATIONS

The present application claims priority to and incorporates by reference the entire contents of Japanese Patent Application No. 2010-031807 filed in Japan on Feb. 16, 2010.

### BACKGROUND OF THE INVENTION

1. Field of the Invention

The present invention is directed generally to a license management system, a license management method, and a computer program product.

2. Description of the Related Art

License management systems that implement floating licensing for managing licenses for computer program instructions (hereinafter, “program”) among users have conventionally been known. Floating licensing is one of licensing approach that enables a program on a device connected with a network to operate. Floating licensing is implemented such that the device borrows a license when using the program and returns the license after use of the program. This brings an advantage that, in a situation where a single company owns a plurality of devices and the program is not used by all of the devices concurrently, the company can purchase licenses depending on the number of devices, on which the program will be used. Floating licensing is also advantageous in that a program is operable on any device irrespective of location of the device because there is no need to fix the devices on which the program is installed. Namely it is possible to operate the program on any device so long as the number of devices does not exceed an obtained number of licenses.

As a form of providing a license from a management server to a device, a trial-version license that permits a program to be used for a trial for a limited period of time and/or with reduced functions before the license management server provides a formal version license to the device has also been already known.

In a floating licensing system, there may be a case in which all of the formally obtained licenses are being used, and still more devices exceeding the number of the formally obtained licenses need to use the program. In such a case as described above, a technique of renting out trial-version licenses to the devices exceeding the number of the formally obtained licenses is disclosed in Japanese Patent Application Laid-open No.2005-251070, for example.

However, the technique disclosed in Japanese Patent Application Laid-open No.2005-251070 is disadvantageous in that a user cannot confirm the number of trial-version licenses being used concurrently with the formal-version licenses because no limitation is imposed on the number of trial-version licenses. More specifically, the technique is disadvantageous because the user cannot obtain a usage status indicating how the program is used by devices and determine whether to additionally purchase formal-version licenses based on the usage status.

### SUMMARY OF THE INVENTION

It is an object of the present invention to at least partially solve the problems in the conventional technology.

According to an aspect of the present invention, a license management system comprises: a plurality of image processing apparatuses; and a license management server that rents out a license to the image processing apparatuses, and the license management server includes: a storage unit that stores a purchased license count, which is number of licenses purchased by a user, and a rented-out license count, which is number of licenses rented out to the image processing apparatuses, the purchased license count and the rented-out license count being associated with type of a program; a first receiving unit that receives a license borrowing request from an image processing apparatus of the plurality of image processing apparatuses; a rent-out control unit that, upon receiving the request, accesses the storage unit to determine whether the rented-out license count is equal to or greater than the purchased license count, and, if the rented-out license count is determined to be equal to or greater than the purchased license count, determines to rent out a trial-version license as the license whereas, if the rented-out license count is determined to be less than the purchased license count, determines to rent out a formal-version license as the license, the trial-version license imposing limitation on some of functions of the program, the formal-version license enabling all the functions of the program; a first transmitting unit that transmits the license determined by the rent-out control unit to the image processing apparatus; an obtaining unit that obtains usage status indicating how the image processing processes use the formal-version licenses and the trial-version licenses; and a first notification unit that notifies the user of the usage status obtained by the obtaining unit, and the image processing apparatus includes: a second transmitting unit that transmits the request; a second receiving unit that receives the license determined by the rent-out control unit; and a starting control unit that determines an operating mode depending on a type of the license received by the second receiving unit and starts up the program in the determined operating mode.

According to another aspect of the present invention, a license management method to be performed by a license management system that includes an image processing apparatus and a license management server that rents out licenses to the image processing apparatus, the license management method comprises: storing a purchased license count, which is number of licenses purchased by a user, and a rented-out license count, which is number of licenses rented out to the image processing apparatus, the purchased license count and the rented-out license count being associated with type of a program; receiving, as first receipt, a license borrowing request from one image processing apparatus of the image processing apparatuses; performing, on receiving the request, rent-out control by accessing the storage unit to determine whether the rented-out license count is equal to or greater than the purchased license count, and, if the rented-out license count is determined to be equal to or greater than the purchased license count, determining to rent out a trial-version license as the license whereas, if the rented-out license count is determined to be less than the purchased license count, determining to rent out a formal-version license as the license, the trial-version license imposing limitation on some of functions of the program, the formal-version license enabling all the functions of the program; transmitting, as first transmission, the license determined at the rent-out control to the one image processing apparatus; obtaining usage status indicating how the image processing processes use the formal-version licenses and the trial-version licenses; notifying, as first notification, the user of the usage status; transmitting, as second transmission, the request; receiving, as second receipt, the license determined at the rent-out control; and performing starting control by determining an operating mode depending on a type of the license received at the second receipt and starting up the program in the operating mode, the operating mode designating an operating condition of the program, and the storing, the first receipt, the rent-out control, the first transmission, the obtaining, and the first notification are performed by the license management server, and the second transmission, the second receipt, and the starting control are performed by the one image processing apparatus.

According to still another aspect of the present invention, a computer program product comprising a computer readable medium having computer readable program instructions that, when executed on a computer connected to image processing apparatus and to a license management server that rents out licenses to the image processing apparatuses, cause the computer to execute: storing a purchased license count, which is number of licenses purchased by a user, and a rented-out license count, which is number of licenses rented out to the image processing apparatuses, the purchased license count and the rented-out license count being associated with type of a program; receiving, as first receipt, a license borrowing request from one image processing apparatus of the image processing apparatuses; performing, on receiving the request, rent-out control by accessing the storage unit to determine whether the rented-out license count is equal to or greater than the purchased license count, and, if the rented-out license count is determined to be equal to or greater than the purchased license count, determining to rent out a trial-version license as the license whereas, if the rented-out license count is determined to be smaller than the purchased license count, determining to rent out a formal-version license as the license, the trial-version license imposing limitation on some of functions of the program, the formal-version license enabling all the functions of the program; transmitting, as first transmission, the license determined at the rent-out control to the one image processing apparatus; obtaining usage status indicating how the image processing processes use the formal-version licenses and the trial-version licenses; notifying, as first notification, the user of the usage status; transmitting, as second transmission, the request; receiving, as second receipt, the license determined at the rent-out control; and performing starting control by determining an operating mode depending on a type of the license received at the second receipt and starting up the program in the operating mode, the operating mode designating an operating condition of the program, and the storing, the first receipt, the rent-out control, the first transmission, the obtaining, and the first notification are performed by the license management server, and the second transmission, the second receipt, and the starting control are performed by the one image processing apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating the configuration of a license management system according to an embodiment of the present invention;

FIG. 2 is a schematic system configuration diagram of a license management server in the license management system;

FIG. 3 is a schematic hardware configuration diagram of a device in the license management system;

FIG. 4 is a schematic software configuration diagram of the device;

FIG. 5 is a block diagram illustrating a functional configuration of an application-installation control service of the device;

FIG. 6 is a sequence diagram illustrating a procedure for a formal-version license rent out process to be performed by the license management system;

FIG. 7 is a sequence diagram illustrating a procedure for a trial-version-license rent out process to be performed by the license management system;

FIG. 8 is a flowchart illustrating a procedure for a program startup process to be performed by the device;

FIG. 9 is a flowchart illustrating a procedure for a process, to be performed by the license management server, of storing a number of rent out licenses;

FIG. 10 is a sequence diagram illustrating a procedure for a process of completing a program enabled under a formal-version license;

FIG. 11 is a sequence diagram illustrating a procedure for a process of completing a program used under a trial-version license;

FIG. 12 is a flowchart illustrating a procedure for a process, to be performed by the device, of completing a program used under a formal-version license;

FIG. 13 is a flowchart illustrating a process, to be performed by the license management server, of receiving a license return process from the device;

FIG. 14 is an example of a formal-version license rent out history stored in an HDD in the license management server;

FIG. 15 is an example of a trial-version-license rented out history stored in the HDD;

FIG. 16 is an example of a line graph charting a license usage status of devices;

FIG. 17 is a diagram illustrating an example notification fed from a first notification unit and displayed on an operation display unit of the license management server;

FIG. 18 is a diagram illustrating an example license usage status displayed on the operation display unit by using a web browser;

FIG. 19 is a diagram illustrating an example of an e-mail to be transmitted from the first notification unit to a user administrating the license management server;

FIG. 20 is a diagram illustrating an example of a program startup screen to be displayed on an operation display unit of the device;

FIG. 21 is a diagram illustrating an example of a start screen for initial settings;

FIG. 22 is a diagram illustrating an example of a software management screen;

FIG. 23 is a diagram illustrating an example of a license-usage-status checking screen;

FIG. 24 is a diagram illustrating an example of a license-usage-status presentation screen;

FIG. 25 is a sequence diagram illustrating a procedure for a license-usage-status notification process to be performed by the license management server;

FIG. 26 is a sequence diagram illustrating a procedure for a process, to be performed by the license management server, of displaying a number of trial-version-licenses that is rented out on a screen;

FIG. 27 is a diagram illustrating an example of a trial-version license rent out notification screen;

FIG. 28 is a schematic diagram illustrating an example of an operation setting screen for a trial-version license;

FIG. 29 is an example of a document output in a “CHARACTER-STRING EMBEDDING” mode;

FIG. 30 is a diagram illustrating an example of an error notification screen that is to appear in an “ONLY SETTING CONFIGURATION PERMITTED” mode; and

FIG. 31 is a diagram illustrating an example of an error notification screen that is to appear when an attempt of starting a copier application is made in a “TRIAL-VERSION DISABLED” mode.

### DETAILED DESCRIPTION OF THE PREFERRED EMBODIMENTS

Exemplary embodiments of a license management system, a license management method, and a computer program product according to the present invention are described in detail below with reference to the accompanying drawings. The embodiments will be described by way of examples embodied in an multifunction peripheral (MFP) that has at least two functions of a copier function, a printer function, a scanner function, and a facsimile function; however, the device is not limited thereto.

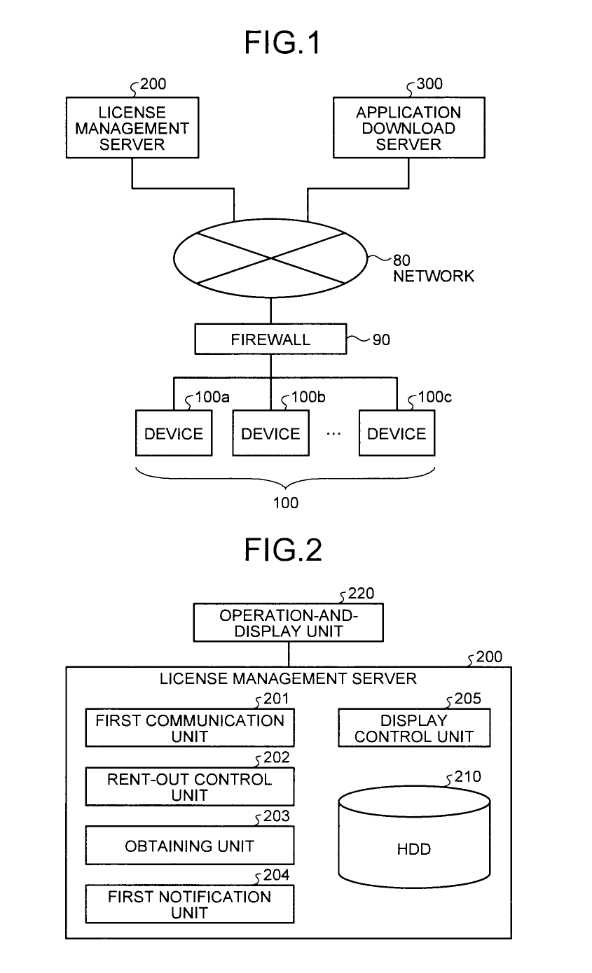

FIG. 1 is a block diagram illustrating the configuration of a license management system according to an embodiment of the present invention. As illustrated in FIG. 1, the license management system includes an application download server 300, a license management server 200, and a plurality of devices 100a, 100b, and 100c (hereinafter, a not-specified device will merely be denoted as “device 100”). The application download server 300 and the license management server 200 are connected to the devices 100 through a network 80, such as the Internet. A firewall 90 is provided between the network 80 and the plurality of devices 100.

The firewall 90 monitors data passing across a boundary with outside, and detects and blocks unauthorized access so as to prevent unauthorized operation from being performed by a third party that has intruded into the license management system via an external network, such as a public line or the Internet.

Each of the devices 100 has a plurality of functions to serve as a copier, a facsimile, a printer, and the like. The devices 100 are connected to one another through a local network, such as a local area network (LAN). In the license management system according to the present embodiment, three devices 100a, 100b, and 100c, are connected; however, the number of the devices 100 is not limited to three, and the remote management system may include one, two, four, or more MFPs.

The application download server 300 is an apparatus that stores application programs (hereinafter, “applications”) for use by the devices 100 and provides the applications to the devices 100.

The license management server 200 is an apparatus that manages licenses (right to use) of applications provided by the application download server 300 and to be installed on the devices 100.

To implement the remote management, according to the license management system of the present embodiment, each device is provided with a function capable of receiving and transmitting a request and a response of process toward a method of an application that is mutually implemented in the devices 100 by using remote procedure call (RPC). The license management system of the present embodiment is capable of utilizing protocols, such as SOAP (simple object access protocol), and FTP (file transfer protocol) to implement RPC.

A system configuration of the license management server 200 will be described below. FIG. 2 is a system configuration diagram of the license management server 200. As illustrated in FIG. 2, the license management server 200 mainly includes: a first communication unit 201; a rent-out control unit 202; an obtaining unit 203; a first notification unit 204; a display control unit 205; an HDD (hard disk drive) 210, and an operation display unit 220.

The HDD 210 stores license information therein. The license information is information about a license that permits the device 100 to use computer program instructions (hereinafter, “program”). The license information includes, for instance, a product key associated with the license, expiration time of the license, the number of purchased licenses (hereinafter, “purchased-license count”), and the number of licenses rented out to the devices 100 (hereinafter, “rented-out license count”). The rented-out license count may be broken down into the number of formal version licenses (hereinafter, “rented-out formal-version license count”) and the number of trial-version licenses rented out to the devices 100 (hereinafter, “rented-out trial-version-license count”).

The first communication unit 201 exchanges data with the devices 100 through the network 80. For instance, the first communication unit 201 receives a license borrowing request from one of the devices 100. The license borrowing request is a request for borrowing a license that allows a program installed on the device 100 to run. The first communication unit 201 also transmits a formal-version license or a trial-version license to the device 100 in response to the license borrowing request from the device 100. The first communication unit 201 corresponds to the first receiving unit and the first transmitting unit of the present invention.

When the first communication unit 201 receives a license borrowing request, the rent-out control unit 202 refers to the HDD 210 and determines the type of license to rent out. The type of license includes a trial-version license and a formal-version license. The trial-version license is a license that is not allowed to use some of the functions of a program whereas the formal-version license is a license that is allowed to use all the functions of the program.

More specifically, the rent-out control unit 202 determines whether the rented-out license count is equal to or greater than the purchased-license count. If the rented-out license count is determined to be equal to or greater than the purchased-license count, the rent-out control unit 202 determines to rent out a trial-version license. If the rented-out license count is determined to be smaller than the purchased-license count, the rent-out control unit 202 determines to rent-out a formal-version license.

The obtaining unit 203 obtains information (hereinafter, “license usage status”) indicating how the formal-version license and trial-version license are used by the devices 100. For instance, the obtaining unit 203 obtains license rent-out time and license return time for each of the license types. A rent-out history and a return history that include the thus-obtained license rent-out times and license return times, respectively, are stored in the HDD 210. The HDD 210 may store a formal-license rent-out history and a trial-version-license rent-out history separately.

The first notification unit 204 notifies a user of the usage status obtained by the obtaining unit 203. For instance, the first notification unit 204 causes the display control unit 205 to display the license usage status on the operation display unit 220. The first notification unit 204 may be configured to display the license usage status on an operation display unit of the device 100. The first notification unit 204 may be configured to send an electronic mail (e-mail) to notify the device 100 of the license usage status.

The display control unit 205 displays various types of information on the operation display unit 220. For instance, the display control unit 205 displays the usage status obtained by the obtaining unit 203 on the operation display unit 220.

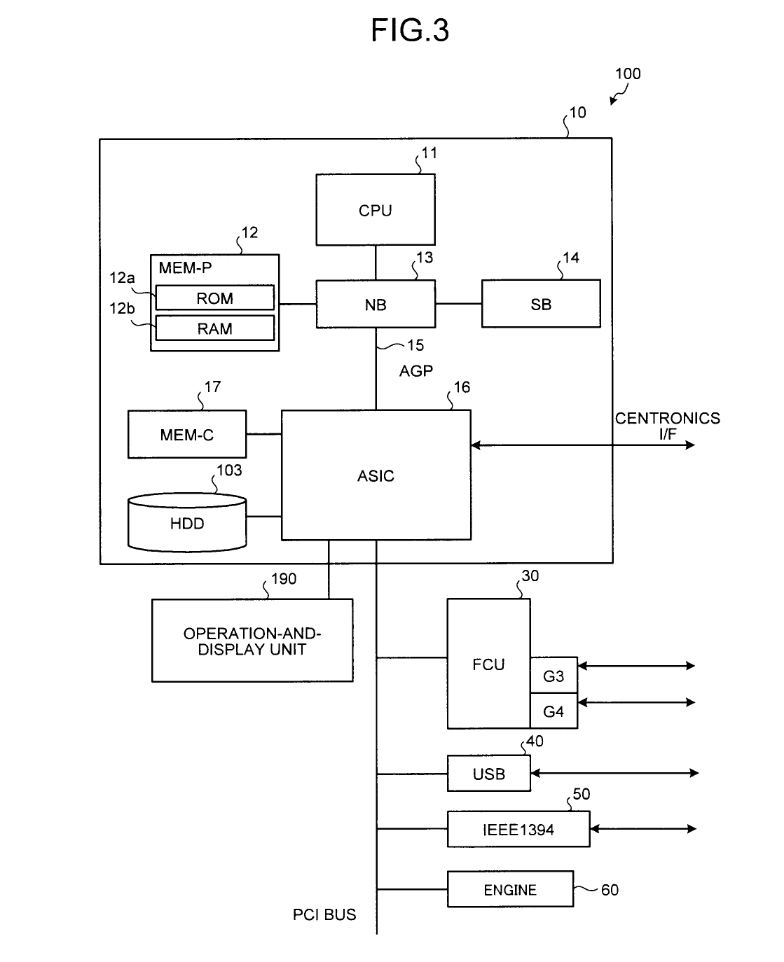

The device 100 will be described below. FIG. 3 is a schematic hardware configuration diagram of the device 100 according to the present embodiment. As illustrated in FIG. 3, the device 100 includes a controller 10 and an engine 60 that are connected together through a PCI (peripheral component interface) bus. The controller 10 is a controller that controls the overall device 100, drawing, communications, and input entered via an operating unit (not shown). The engine 60 is a printer engine or the like that is connectable to the PCI bus. The engine 60 includes a monochrome plotter, a one-drum color plotter, a four-drum color plotter, a scanner, and a facsimile unit. The engine 60 includes, in addition to what is called an engine section such as the plotter, an image processing section that performs error diffusion, gamma conversion, and the like.

The controller 10 includes: a CPU 11 (central processing unit); a north bridge (NB) 13; a system memory (hereinafter, “MEM-P”) 12; a south bridge (SB) 14; a local memory (hereinafter, “MEM-C”) 17; an ASIC (Application-Specific Integrated Circuit) 16; and an HDD 103. An AGP (accelerated graphics port) bus 15 connects between the NB 13 and the ASIC 16. The MEM-P 12 includes a ROM (read only memory) 12a and a RAM (random access memory) 12b.

The CPU 11 controls the overall device 100 and includes a chipset that includes the NB 13, the MEM-P 12, and the SB 14. The CPU 11 is connected to another device via the chipset.

The NB 13 is a bridge for connecting the CPU 11 to the MEM-P 12, the SB 14, and the AGP 15. The NB 13 includes a PCI master, an AGP target, and a memory controller that controls reading and writing from and to the MEM-P 12 and the like.

The MEM-P 12 that includes the ROM 12a and the RAM 12b is a system memory for use as memory for storing program instructions and data, for loading program instructions and data thereinto, for use in rendering for the printer, and the like. The ROM 12a is read only memory for use as memory for storing program instructions and data. The RAM 12b is writable and readable memory for use as memory for loading program instructions and data thereinto, as memory for use in rendering for the printer, and the like.

The SB 14 is a bridge for connecting the NB 13 to a PCI device and peripheral devices. The SB 14 is connected to the NB 13 via the PCI bus, to which a network I/F and the like are also connected.

The ASIC 16, which is an integrated circuit (IC) for use in image processing, includes a hardware component for the image processing and functions as a bridge that connects the AGP 15, the PCI bus, an HDD 103, and the MEM-C 17 with each other. The ASIC 16 includes a PCI target and an AGP master, an arbiter (ARB) serving as the core for the ASIC 16, a memory controller that controls the MEM-C 17, a plurality of direct memory access controllers (DMACs) that performs data processing related to rotation of image data and the like by hardware logic, and a PCI unit that performs data transfer to and from the engine 60 via the PCI bus. A facsimile control unit (FCU) 30, a universal serial bus (USB) 40, and an IEEE 1394 I/F 50 are connected to the ASIC 16 via the PCI bus. An operation display unit 190 is directly connected to the ASIC 16.

The MEM-C 17 is local memory for use as a copy image buffer and a code buffer. The HDD 110 is a storage for storing image data, program instructions, font data, and forms.

The AGP 15 is a bus interface for a graphics accelerator card introduced to speed up graphics operations and allows direct access to the MEM-P 12 with a high throughput, thereby speeding up operations related to the graphic accelerator card.

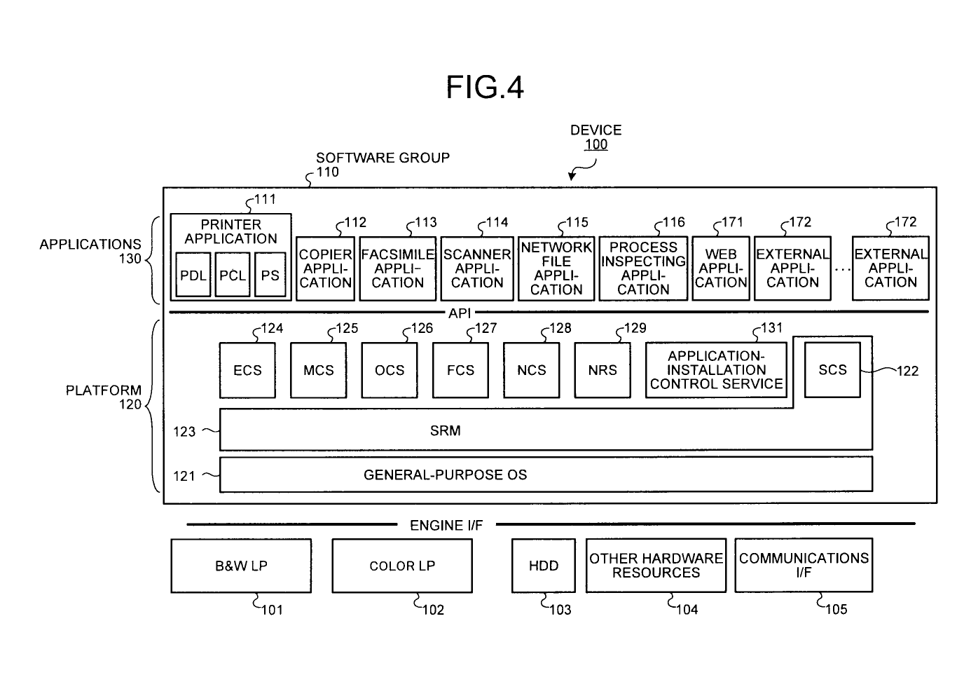

FIG. 4 is a schematic software configuration diagram of the MFP according to the present embodiment. As illustrated in FIG. 4, the device 100 includes: a black-and-white laser printer (B&W LP) 101; a color laser printer (color LP) 102; the HDD 103; hardware resources 104, such as a scanner, a facsimile, and memory; a communications interface (I/F) 105; and a software group 110 that includes a platform 120 and applications 130.

The platform 120 includes control services, a system resource manager (SRM) 123 that manages one or more hardware resources and arbitrates resource requests from the control services, and a general-purpose operating system (OS) 121. Each control service interprets a process request fed from an application and issues a request for obtaining a hardware resource.

The control services include a plurality of service modules, or more specifically include: a system control service (SCS) 122; an engine control service (ECS) 124; a memory control service (MCS) 125; an operation-panel control service (OCS) 126; a facsimile control service (FCS) 127; a network control service (NCS) 128; a new remote service (NRS) 129; and an application-installation control service 131. The platform 120 includes an application program interface (API) that allows receipt of processing request from the applications 130 by using functions defined in advance.

The general-purpose OS 121, which is a general-purpose operating system such as UNIX (registered trademark), executes each of the software programs of the platform 120 and the applications 130 concurrently as a process, respectively.

The process of the SRM 123 is to perform a system control and resource management together with the SCS 122. More specifically, the SRM 123 performs a process for arbitration, execution, and control according to a request fed from an upper layer that uses hardware resources of: such as the engine, e.g. for the scanner unit or the printer unit; memory; an HDD file; and a host input/output (I/O) (e.g., a Centronics I/F, a network I/F, an IEEE 1394 (the Institute of Electrical and Electronics Engineers 1394) I/F, or an RS-232C I/F).

More specifically, the SRM 123 determines whether the requested hardware resource is available (i.e., whether the requested hardware resource is currently used for another request), and if the requested hardware resource is available, sends a notification that the requested hardware resource is available to the upper layer. The SRM 123 also arranges, in response to a request from the upper layer, a schedule for utilization of hardware resource and directly performs a requested operation (e.g., causing a printer engine to perform paper feeding and image forming, memory allocation, file creation, and the like).

The process of the SCS 122 is for performing an application management, control of the operating unit, displaying system-related screens, LED (light-emitting diode) display), resource management, control of application interruption, and the like.

The process of the ECS 124 is for performing engine control of the hardware resources 104 that include the B&W LP 101, the color LP 102, the scanner, and the facsimile.

The process of the MCS 125 is for performing acquisition and release of image memory, utilization of the HDD, compression and decompression of image data, and the like.

The process of FCS 127 includes: facsimile transmission to and reception from each application layer of a system controller by using public switched telephone network (PSTN) or integrated services digital network (ISDN) network; storing and retrieving various facsimile data managed by BKM (a backup SRAM); scanning for facsimile transmission; printing of received facsimile data; and providing an API for performing combined transmission and reception.

The process of NCS 128 is a process to provide applications that require network I/O with services that are commonly usable. More specifically, the NCS 128 allocates data pieces received via the network by using various protocols to the applications and intermediates data transmission from the applications to the network.

In the present embodiment, the process of the NCS 128 is a process for receiving an installation request and an uninstallation request, in addition to application and license information. When an application has successfully been installed according to an installation request, the process of the NCS 128 performs a process for sending a notification of completion of the installation to the intermediary apparatus 200. In contrast, when an attempt to install an application according to an installation request has failed, the NCS 128 sends a notification of uncompleted installation to the intermediary apparatus 200. When an application has successfully been uninstalled according to an uninstallation request, the NCS 128 sends a notification of completion of uninstallation to the intermediary apparatus 200. In contrast, when an attempt to uninstall an application according to an uninstallation request has failed, the NCS 128 sends a notification of uncompleted uninstallation to the intermediary apparatus 200.

The process of OCS 126 is for controlling an operation panel (control panel) that serves as an interface between an operator (user) and control of the apparatus. When a key is pressed (or touched) on the operation panel, the OCS 126 acquires it as a key event. The OCS 126 includes a portion serving as an OCS process that transmits a key event function corresponding to the thus-acquired key to the SCS 122 and a portion serving as an OCS library. Functions that cause various images to be formed and displayed on the operation panel according to a request from any one of the applications 130 and the control services, other control functions related to the operation panel, and the like are registered in the OCS library in advance. The OCS library is implemented as being linked with various modules of the applications 130 and the control services. The entire OCS 126 may be configured so as to operate as the OCS process. Alternatively, the entire OCS 126 may be configured as the OCS library.

The application-installation control service 131 performs a process for installing the application by using the received application and the license information based on the installation request received in the process performed by the NCS 128. The application-installation control service 131 performs a process for uninstalling the application by using the received license information based on the uninstallation request received in the process performed by the NCS 128.

The process of NRS 129 includes: a function related to device remote management, such as data conversion for transmission and reception of data via the network, via a network; and a scheduler function.

The applications 130 include: a printer application 111 that is an application for a printer with a page description language (PDL) and a post script (PS); a copier application 112 that is an application for a copier; a facsimile application 113 that is an application for a facsimile; a scanner application 114 that is an application for a scanner; a network file application 115 that is an application for a network file; a process inspecting application 116 that is an application for process inspection; and a web application 117 that serves as a web server (hypertext transfer protocol (http) server) and displays various screens on a web browser that is run on a client terminal.

Each of processes performed by the applications 130 and the processes performed by the control services provides user service related to image forming operation of a copier, a printer, a scanner, a facsimile, or the like by performing function call and return value transmission in response to the function call and exchanging messages for inter-process communications.

As described above, the device 100 according to the embodiment includes the plurality of applications 130 and the plurality of control services, each of which is operated as a process. One or a plurality of threads are generated in each of the processes to perform the processes by multi-threading. The control services provide common services to the applications 130. Accordingly, a large number of processes are performed by multi-tasking and multi-threading while carrying out inter-process communications for cooperation with one another, thereby providing user services, such as the copier, the printer, the scanner, or the facsimile, related to image forming operations.

The device 100 is configured such that a third party, such as a customer or a third vendor, of the device 100 can develop an external application 172 and install the external application 172 on an application layer, which is an upper layer of a control service layer. The external application 172 is an application fed from the intermediary apparatus 200 and to be installed by the application-installation control service 131.

In the device 100 according to the embodiment, the plurality of processes of the application 130 and the plurality of processes of the control services are run; however, another configuration may be employed in which a single process of the application programs 130 and a single process of the control services are operated, respectively. Addition to or deletion of an application from the applications 130 can be performed on an application-by-application-basis. In other words, as described above, the external application 172 may be installed on or uninstalled from the device 100.

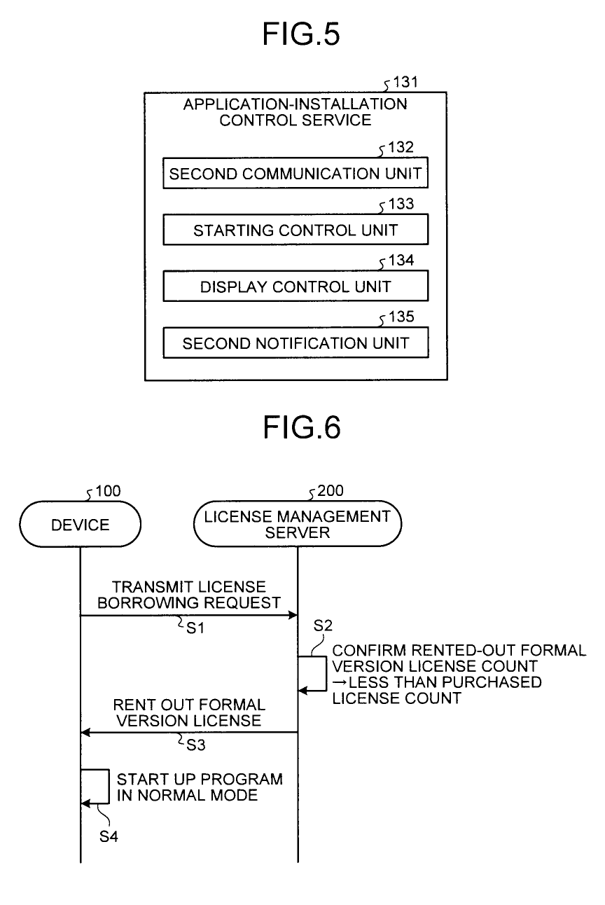

The application-installation control service 131 will be described in detail below. FIG. 5 is a block diagram illustrating a functional configuration of the application-installation control service 131. As illustrated in FIG. 5, the application-installation control service 131 mainly includes: a second communication unit 132; a starting control unit 133; a display control unit 134; and a second notification unit 135.

The second communication unit 132 exchanges data with the license management server 200 through the network 80. For instance, the second communication unit 132 transmits a license borrowing request to the license management server 200. The second communication unit 132 also receives a formal-version license, a trial-version license, license usage status, and the like from the license management server 200. The second communication unit 132 corresponds to the second receiving unit and the second transmitting unit of the present invention.

The starting control unit 133 starts up a program in a different manner depending on a type of the license received by the second communication unit 132. More specifically, when the second communication unit 132 receives a trial-version license, the starting control unit 133 starts up the program in a trial-version mode, whereas when the second communication unit 132 receives a formal-version license, the starting control unit 133 starts up the program in a normal mode. In the trial-version mode, the program is activated with some of functions of the program disabled. In the normal mode, the program is activated with all the functions enabled.

The second notification unit 135 notifies a user of the usage status obtained by the license management server 200. The display control unit 134 displays various pieces of information on the operation display unit 190. For instance, the display control unit 134 displays the usage status received from the license management server 200 on the operation display unit 190.

A formal-license rent-out process to be performed by the license management system configured as described above will be described below. FIG. 6 is a sequence diagram illustrating a procedure for the formal-license rent-out process to be performed by the license management system.

The device 100 transmits a license borrowing request to the license management server 200 (Step S1). Upon receiving the license borrowing request from the device 100, the license management server 200 confirms a rented-out formal-license count (Step S2).

If the rented-out formal-license count is less than a purchased license count, the license management server 200 determines to rent out a formal-version license and transmits the formal-version license to the device 100 (Step S3). Upon receiving the formal-version license from the license management server 200, the device 100 starts up the program in the normal mode (Step S4).

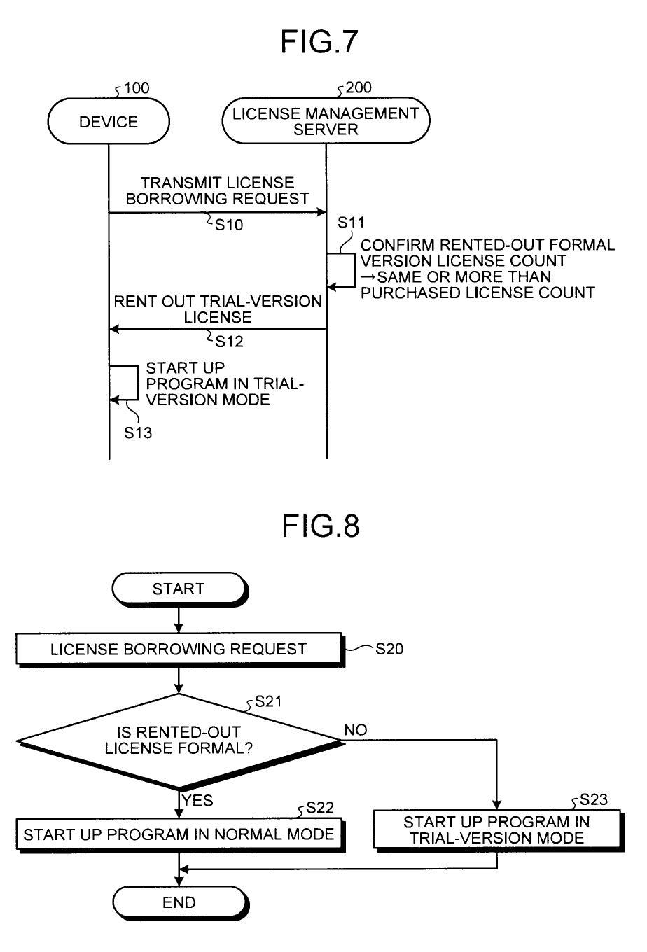

A trial-version-license rent-out process to be performed by the license management system will be described below. FIG. 7 is a sequence diagram illustrating a procedure for the trial-version-license rent-out process to be performed by the license management system.

The device 100 transmits a license borrowing request to the license management server 200 (Step S10). Upon receiving the license borrowing request from the device 100, the license management server 200 confirms a rented-out formal-license count (Step S11).

If the rented-out formal-license count is more than a purchased license count, the license management server 200 determines to rent out a trial-version license and transmits the trial-version license to the device 100 (Step S12). Upon receiving the trial-version license from the license management server 200, the device 100 starts up the program in a trial-version mode (Step S13).

A program startup process to be performed by the device 100 will be described below. FIG. 8 is a flowchart illustrating a procedure for the program startup process to be performed by the device 100.

The second communication unit 132 transmits a license borrowing request to the license management server 200 (Step S20). The starting control unit 133 determines whether a license rented out from the license management server 200 is a formal-version license (Step S21).

If the rented-out license is determined to be a formal-version license (YES at Step S21), the starting control unit 133 starts up the program in the normal mode (Step S22). In contrast, if the rented-out license is determined to be a trial-version license (NO at Step S21), the starting control unit 133 starts up the program in the trial-version mode (Step S23).

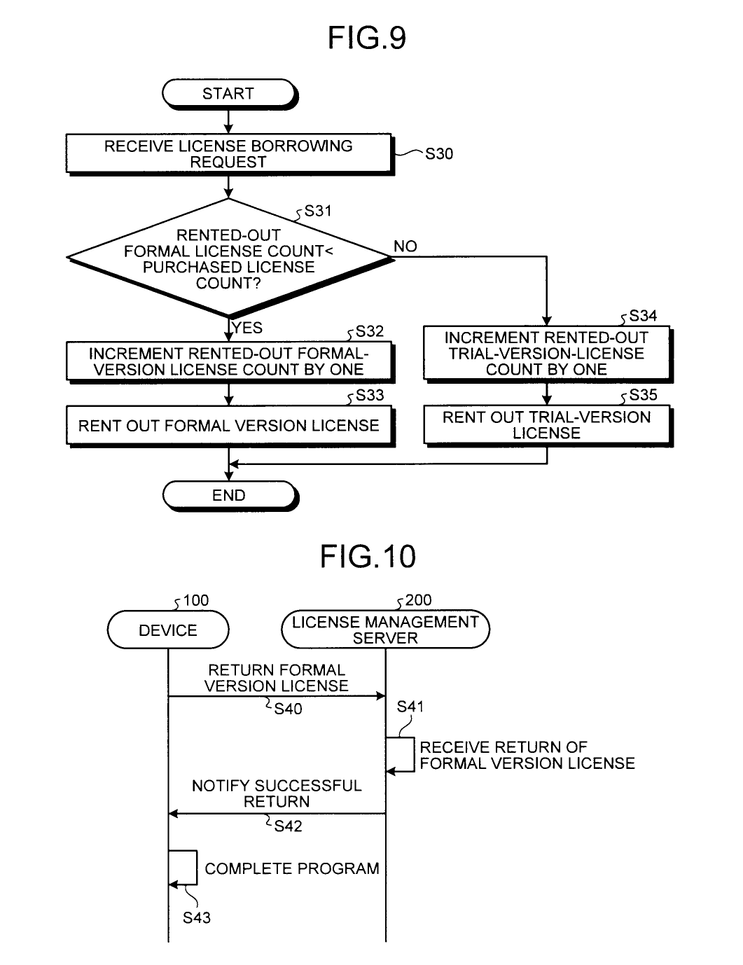

A process, to be performed by the license management server 200, of storing a rented-out license count will be described below. This process is involved in the license rent-out process described above with reference to FIG. 6 and FIG. 7. FIG. 9 is a flowchart illustrating a procedure for the process, to be performed by the license management server 200, of storing a rented-out license count.

The first communication unit 201 receives a license borrowing request from the device 100 (Step S30). The rent-out control unit 202 confirms a rented-out formal-license count (Step S31). If the rented-out formal-license count is determined to be less than a purchased license count (YES at Step S31), the rent-out control unit 202 increments the rented-out formal-license count stored in the HDD 210 by one (Step S32). The rent-out control unit 202 rent out a formal-version license to the device 100 (Step S33).

In contrast, if the rented-out formal-license count is determined to be equal to or greater than the purchased license count (NO at Step S31), the rent-out control unit 202 increments the rented-out trial-version-license count stored in the HDD 210 by one (Step S34). The rent-out control unit 202 rents out a trial-version license to the device 100 (Step S35).

A process of completing a program used under a formal-version license will be described below. FIG. 10 is a sequence diagram illustrating a procedure for the process of completing a program used under a formal-version license.

Upon receiving completion of using the program, the device 100 returns the formal-version license to the license management server 200 (Step S40). The license management server 200 receives the return of the formal license (Step S41). Upon receiving the return of the formal license, the device 200 sends a notification of successful return of the formal license to the device 100 (Step S42). Upon receiving the notification of successful return of the formal license from the license management server 200, the device 100 completes the program (Step S43).

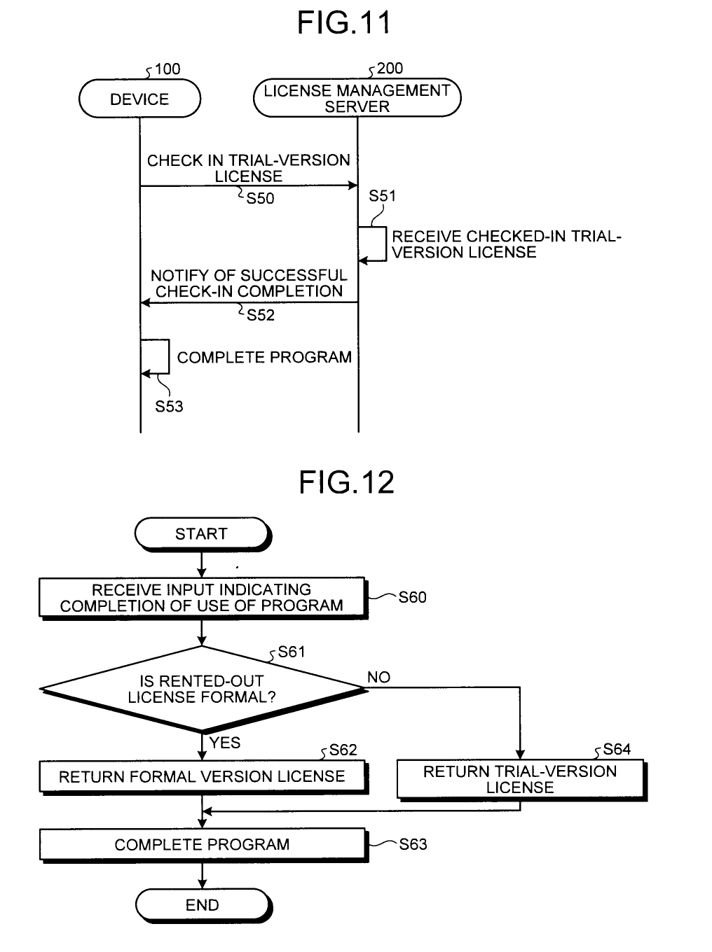

A process for completing a program used under a trial-version license will be described below. FIG. 11 is a sequence diagram illustrating a procedure for the process for completing a program used under a trial-version license.

The device 100 returns the trial-version license (Step S50). The license management server 200 receives the trial-version license (Step S51). Upon receiving the trial-version license, the device 200 sends a notification of successful reception of the trial-version license to the device 100 (Step S52). Upon receiving the notification of successful reception of the trial-version license from the license management server 200, the device 100 completes the program (Step S53).

A process to be performed by the device 100 to complete a program used under a formal-version license will be described below. FIG. 12 is a flowchart illustrating a procedure for the process, to be performed by the device 100, of completing a program used under a formal-version license.

The device 100 receives a notification of the completion of the use of the program from a user (Step S60). The device 100 confirms whether a license rented out for the program is a formal-version license (Step S61). If the rented-out license is determined to be a formal-version license (YES at Step S61), the device 100 returns the formal-version license to the license management server 200 (Step S62).

Meanwhile, if the rented-out license is determined to be a trial-version license (NO at Step S61); the device 100 returns the trial-version license to the license management server 200 (Step S64). After returning the formal-version license or the trial-version license to the license management server 200, the device 100 completes the program (Step S63).

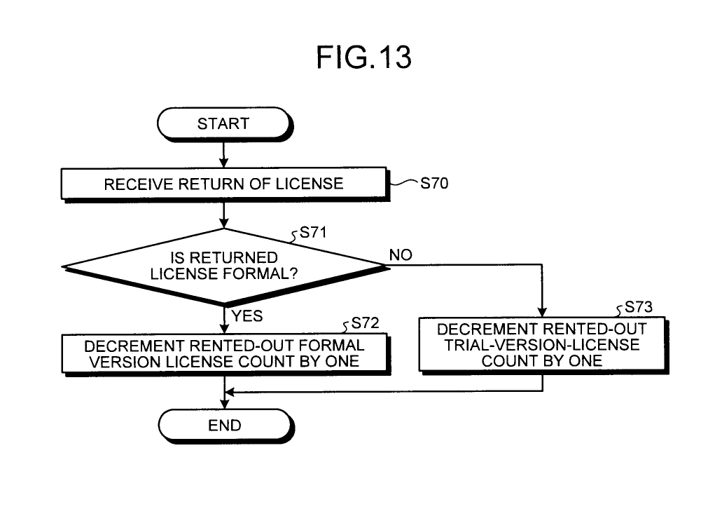

A license return, from the device 100, reception process to be performed by the license management server 200 will be described below. FIG. 13 is a flowchart illustrating the license return process to be performed by the license management server 200 to receive a license return from the device 100.

The license management server 200 receives the license return from the device 100 (Step S70). The license management server 200 confirms whether the returned license is a formal-version license (Step S71). If the returned license is determined to be a formal-version license (YES at Step S71), the license management server 200 decrements the rented-out formal-license count stored in the HDD 210 by one (Step S72).

In contrast, if the returned license is determined to be a trial-version license (NO at Step S71), the license management server 200 decrements the rented-out trial-version-license count stored in the HDD 210 by one (Step S73).

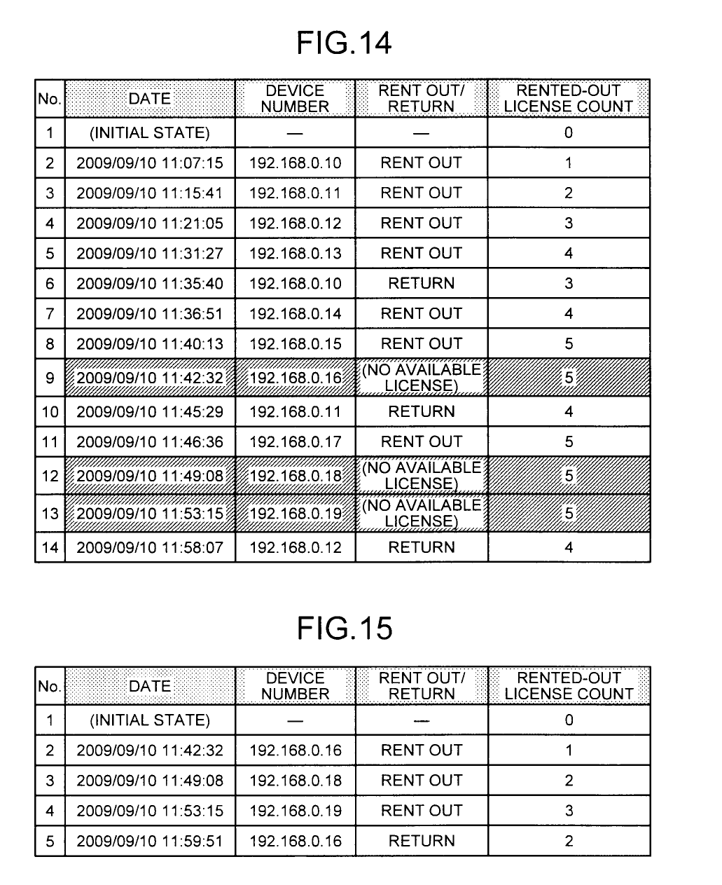

A license-usage-status obtaining process to be performed by the license management server 200 will be described below. FIG. 14 is an example of a formal-license rent-out history stored in the HDD 210. As illustrated in FIG. 14, a formal-version license is not rented out to any of the devices 100 in the initial state (earlier than “Oct. 9, 2009 11:07:15”) given in the row numbered “1”, where the rented-out license count is zero.

In the row numbered “2”, the license management server 200 has rented out a formal-version license because the license management server 200 has received a license borrowing request from one of the devices 100 of which identification number is (192.168.0.10). Accordingly, the license management server 200 increments the rented-out license count by one to set the count to one. In each of the rows numbered from “3” to “5”, the license management server 200 has rented out a formal-version license to one of the devices 100 in response to a license borrowing request. The ones of the devices 100 in the rows numbered from “3” to “5” differ from the one of the devices 100 in the row numbered “2”. In the row numbered “6,” the license management server 200 has received the formal-version license returned from the device 100 identified by (192.168.0.10) that has been borrowed at the row numbered “2”. Accordingly, the license management server 200 decrements the rented-out license count by one to set the count to three.

In each of the rows numbered “7” and “8”, the license management server 200 has rented out a formal-version license to one of the devices 100 in response to a license borrowing request. Identification numbers of the devices 100 in the rows numbered “7” and “8” differ from those of the devices 100 in the rows numbered from “2” to “5”. At the row numbered “8”, the rented-out license count has reached five, which is purchased license count.

In the row numbered “9”, although the license management server 200 has further received a license borrowing request from another one of the devices 100 identified by (192.168.0.16), the license management server 200 cannot rent out a formal-version license because the rented-out license count has reached five, which is equal to the purchased license count. Accordingly, the license management server 200 does not update the rented-out formal-license count stored in the HDD 210. In this case, the license management server 200 rents out a trial-version license to the device 100 of which identification number is (192.168.0.16). The rows numbered from “10” to “14” similarly indicate history about rent-out and return of formal-version licenses by the license management server 200 and the devices 100; and also indicate history about rent out of the trial-version license.

A license-usage-status obtaining process to be performed by the license management server 200 will be described below. FIG. 15 is an example of a trial-version-license rent-out history stored in the HDD 210. As illustrated in FIG. 15, the license management server 200 has not rented out a trial-version license to any of the devices 100 in the initial state (earlier than “Oct. 9, 2009 11:42:32”) given in the row numbered “1”, where the rented-out license count is zero.

In the row numbered “2”, as explained in FIG. 14, the license management server 200 has rented out a trial-version license because the rented-out formal-license count has exceeded the purchased license count. Accordingly, the license management server 200 has incremented the rented-out license count by one to set the count to one. In each of the rows numbered “3” and “4”, the license management server 200 has similarly rented out a trial-version license in response to a license borrowing request from one of the devices 100.

In the row numbered “5”, the license management server 200 has received the trial-version license returned from the device 100 identified by (192.168.0.16) that has borrowed the license in the row numbered “2”. Accordingly, the license management server 200 has decremented the rented-out license count stored in the HDD 210 by one to set the count to two.

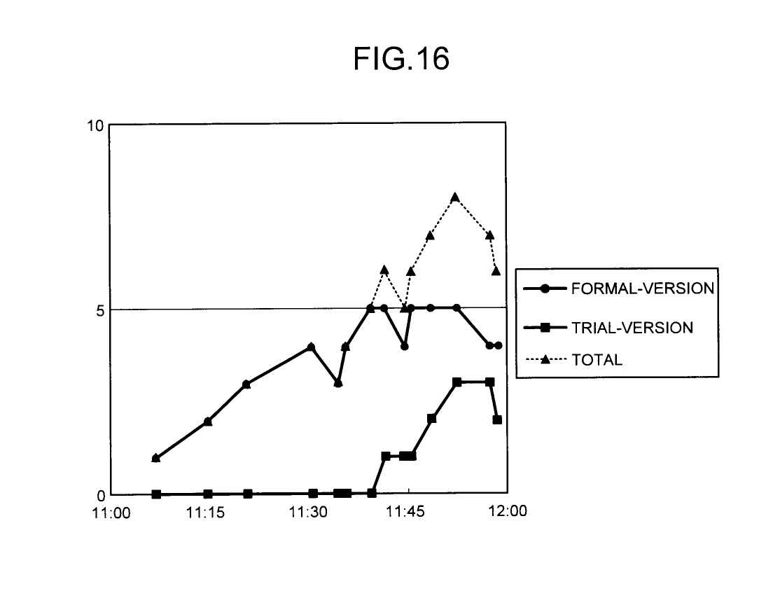

A license usage status indicating how the devices 100 use licenses will be described below. FIG. 16 is an example of a line graph charting a license usage status of the devices 100. The line graph given in FIG. 16 depicts a license usage status of the devices 100 over one hour from 11:00 to 12:00. In FIG. 16, a solid line with circles indicates rented-out formal-license counts; a solid line with squares indicates rented-out trial-version-license counts; a dashed line with triangles indicates values of total of the rented-out formal-license count and the rented-out trial-version-license count. Note that when the rented-out formal-license count has reached five, the license management server 200 rents out a trial-version license to the device 100. It is indicated that the number of licenses borrowed by the devices 100 is at its peak at 11:50 where the total indicated by the dashed line with triangles is at its maximum.

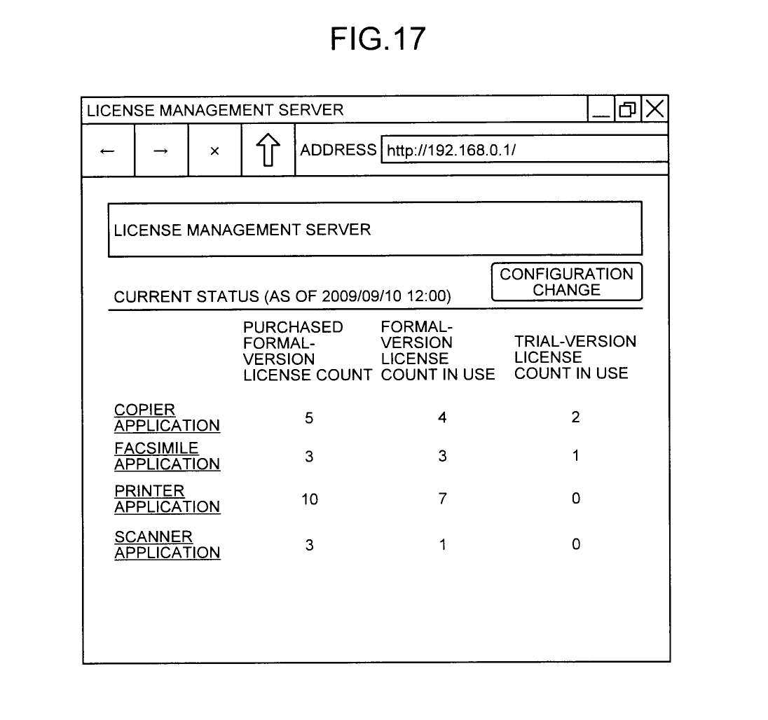

A specific example of a license usage status notification performed by the first notification unit 204 of the license management server 200 will be described below. FIG. 17 is a diagram illustrating an example notification displayed by the first notification unit 204 on the operation display unit 220 of the license management server 200. As illustrated in FIG. 17, the first notification unit 204 causes the display control unit 205 to display a license usage status on the operation display unit 220. The display control unit 205 also indicates that the license management server 200 manages licenses for four programs including the copier application, the facsimile application, the printer application, and the scanner application. The display control unit 205 also indicates that the purchased formal-version license count of the copier application, that of the facsimile application, that of the printer application, and that of the scanner application are five, three, ten, and three, respectively. The display control unit 205 also indicates that rented-out formal-version license count as of Oct. 9, 2009 12:00 of the copier application, that of the facsimile application, that of the printer application, and that of the scanner application are four, three, seven, and one, respectively, while rented-out trial-version license count of the same are two, one, zero, and zero, respectively. The display control unit 205 also displays names of the programs in a hyperliked form. This allows a user to view details of a usage status of each of the programs. The display control unit 205 also displays a “CONFIGURATION CHANGE” button that allows a user to configure operation of a trial-version mode.

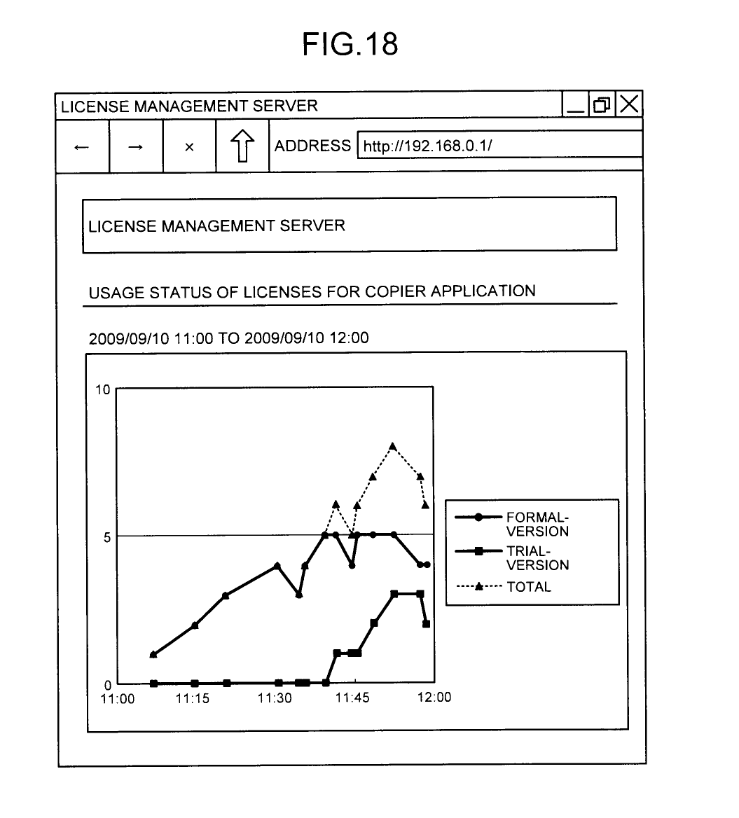

Another specific example of a license usage status notification performed by the first notification unit 204 of the license management server 200 will be described below. FIG. 18 is a diagram illustrating an example license usage status displayed on the operation display unit 220 of the license management server 200 by using a web browser. Also in the example illustrated in FIG. 18, as in the case of FIG. 17, the first notification unit 204 causes the display control unit 205 to display a license usage status on the operation display unit 220. The display control unit 205 displays the line graph charting the license usage status illustrated in FIG. 16 on the operation display unit 220. This allows a user to determine whether the purchased formal-version license count is sufficient in quantity or the formal-version license should be additionally purchased by referring to the line graph charting the license usage status displayed on the operation display unit 220.

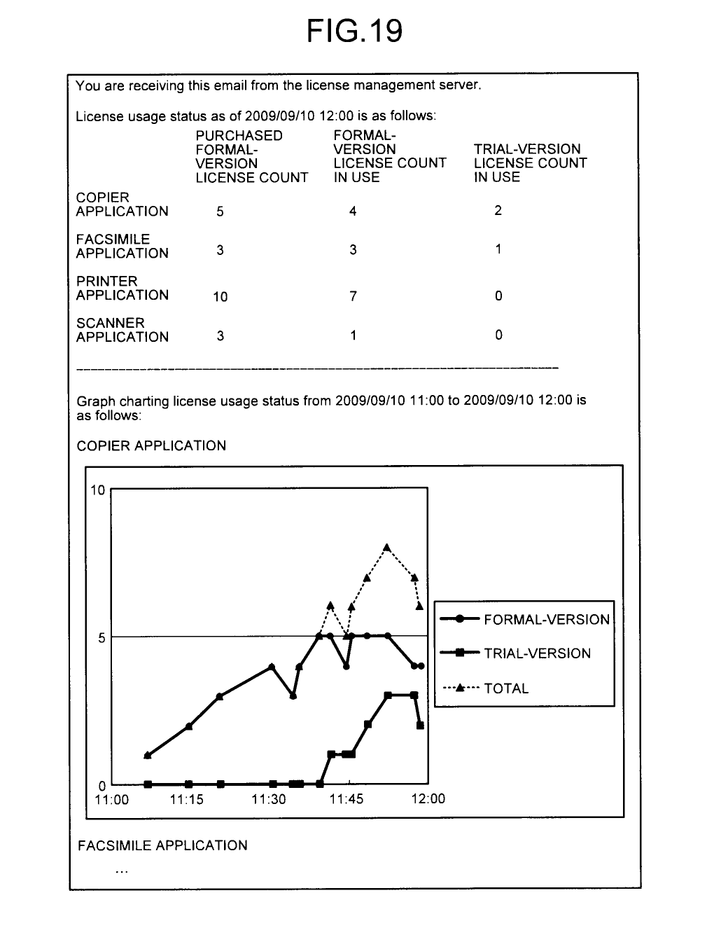

Another specific example of a license usage status notification performed by the first notification unit 204 of the license management server 200 will be described below. FIG. 19 is a diagram illustrating an example of an e-mail transmitted from the first notification unit 204 to a user administrating the license management server 200. The first notification unit 204 transmits the e-mail to notify the user of the usage status via the first communication unit 201. As illustrated in FIG. 19, the first communication unit 201 transmits an e-mail, on which the line graph charting the license usage status illustrated in FIG. 16 is pasted, to the user. This allows the user to determine whether the purchased formal-version license count is sufficient in quantity or the formal-version license should be additionally purchased by referring to the line graph charting the license usage status provided by the first communication unit 201.

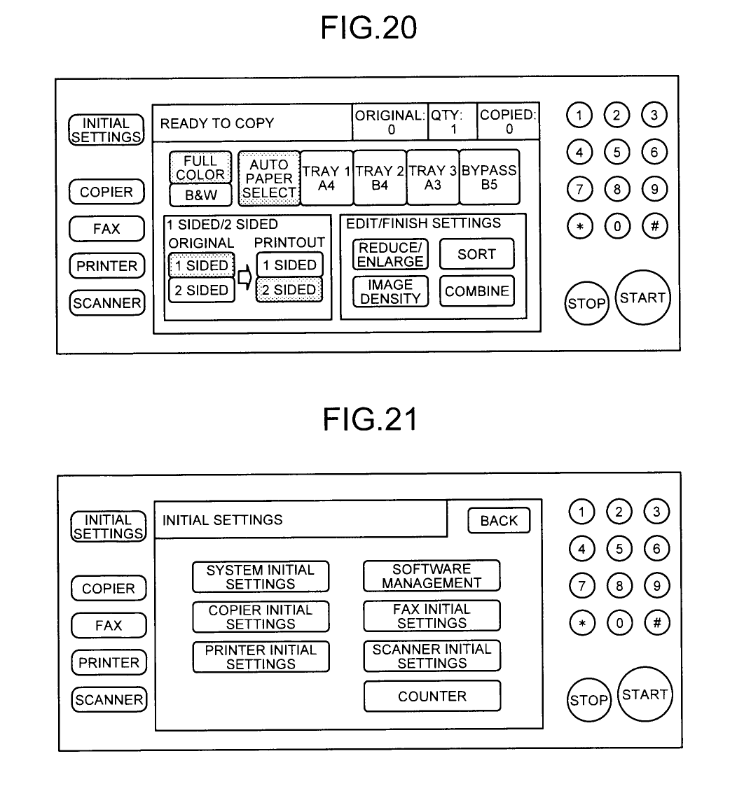

A specific example of operations to be performed by the starting control unit 133 of the device 100 to start up a program will be described below. FIG. 20 is a diagram illustrating an example of a program startup screen to be displayed on the operation display unit 190 of the device 100. As illustrated in FIG. 20, the display control unit 134 displays a control panel on the operation display unit 190. The control panel includes a program start key arranged on the left, a liquid crystal display (LCD) arranged at the center, and a numeric key, a start key, and a stop key arranged on the right. On detecting that the “COPY” key on the left is pressed by a user, the starting control unit 133 starts up a program for the copier application.

The display control unit 134 displays, on the LCD, various messages including “READY TO COPY” indicating that the apparatus is ready to produce a copy, “ORIGINAL: 0” indicating the quantity of originals being scanned, “QTY: 1” indicating the quantity of printouts to be produced, and “COPIED: 0” indicating the quantity of already-produced printouts. The display control unit 134 displays a “FULL COLOR” button and a “B&W” button that allows a user to select a color mode on the LCD. When one of the buttons is selected by the user, the display control unit 134 highlights the thus-selected button so that the user can visually recognize which one of the buttons has been selected. In FIG. 20, a situation where the “FULL COLOR” is selected is displayed because the “FULL COLOR” button is highlighted by the display control unit 134. The display control unit 134 also displays buttons that allow a user to select a paper tray for use in copying on the LCD. In FIG. 20, a situation where an “AUTO PAPER SELECT” button that causes, when selected, printing paper to be automatically selected based on scanned original is selected and highlighted by the display control unit 134 is displayed. The display control unit 134 also displays buttons that allow a user to specify whether an original is one-sided or two-sided and whether a printout is to be one-sided or two-sided on the LCD. In the example illustrated in FIG. 20, the display control unit 134 highlights a “1 SIDED” button for an original and a “2 SIDED” button for a printout. The display control unit 134 further displays buttons that allow a user to configure settings related to editing and finishing, such as a “REDUCE/ENLARGE” button, a “SORT” button, an “IMAGE DENSITY” button, and a “COMBINE” button on the LCD. When any one of these buttons is pressed by a user, the display control unit 134 causes a corresponding setting screen (not shown) to pop up.

A specific example of a start screen for initial settings to be displayed on the operation display unit 190 of the device 100 will be described below. FIG. 21 is a diagram illustrating an example of the start screen for initial settings. As illustrated in FIG. 21, when a user presses the “INITIAL SETTINGS” key arranged on the left, the display control unit 134 causes the start screen for the initial settings to appear on the LCD on the operation display unit 190. The display control unit 134 displays a “SYSTEM INITIAL SETTINGS” button for use in configuring initial settings of overall system, a “COPIER INITIAL SETTINGS” button, a “FAX INITIAL SETTINGS” button, a “PRINTER INITIAL SETTINGS” button, and a “SCANNER INITIAL SETTINGS” for use in configuring settings of the copier application, the facsimile application, the printer application, and the scanner application, respectively, on the LCD. The display control unit 134 also displays a “SOFTWARE MANAGEMENT” button for use in performing license management and installation, uninstallation, and the like of software program, and a “COUNTER” button for use in causing a counter of printing or transmission on the LCD.

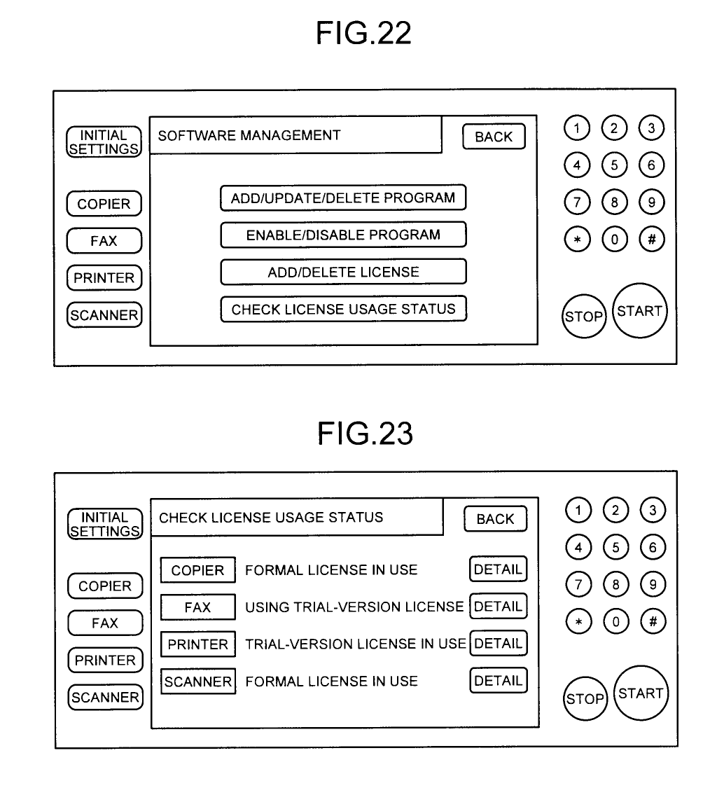

A specific example of a software management screen to be displayed on the operation display unit 190 of the device 100 will be described below. FIG. 22 is a diagram illustrating an example of the software management screen. As illustrated in FIG. 22, the display control unit 134 causes the software management screen to appear on the LCD when the “SOFTWARE MANAGEMENT” button is pressed on the start screen for the initial settings as described above with reference to FIG. 21. The display control unit 134 displays an “ADD/UPDATE/DELETE PROGRAM” button for use in installing (add), updating (update), and uninstalling (delete) a program, an “ENABLE/DISABLE PROGRAM” button for use in temporarily enabling/disabling a program, an “ADD/DELETE LICENSE” button for use in adding and deleting a formal-version license, and a “CHECK LICENSE USAGE STATUS” button for use in checking a formal-license usage status and a trial-version-license usage status of each program on the LCD.

A specific example of a screen (hereinafter, “license-usage-status checking screen”), for use in checking license usage status displayed on the operation display unit 190 of the device 100 will be described below. FIG. 23 is a diagram illustrating an example of the license-usage-status checking screen. As described above with reference to FIG. 22, when the “CHECK LICENSE USAGE STATUS” button is pressed, the display control unit 134 displays the license-usage-status checking screen on the LCD on the operation display unit 190. The display control unit 134 displays whether each application installed on the device is enabled under a formal-version license or enabled under a trial-version license, or the application is not used and hence no license is used on the LCD. The display control unit 134 also displays a “DETAIL” button for each of the applications on the LCD. The “DETAIL” button is used to display detail of the license usage status, which will be described later, of the application.

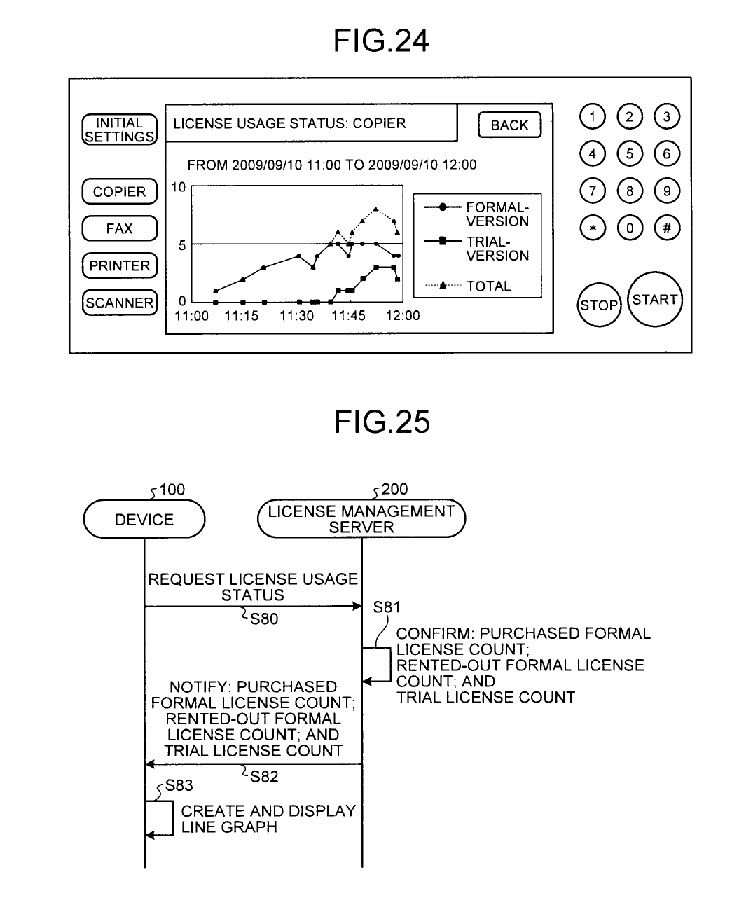

A specific example of a screen (hereinafter, “license-usage-status presentation screen”) that presents a license usage status to be displayed on the operation display unit 190 of the device 100 will be described below. FIG. 24 is a diagram illustrating an example of the license-usage-status presentation screen. As described above with reference to FIG. 23, when the “DETAIL” button of one of the applications on the license-usage-status checking screen is pressed, the display control unit 134 displays the license-usage-status presentation screen of the application on the LCD on the operation display unit 190. The display control unit 134 displays the line graph charting the license usage status illustrated in FIG. 16 on the LCD. This allows a user to determine whether the purchased formal-version license count is sufficient in quantity or the formal-version license should be additionally purchased by referring to the line graph charting the license usage status.

A license-usage-status notification process to be performed by the license management server 200 will be described below. FIG. 25 is a sequence diagram illustrating a procedure for a license-usage-status notification process to be performed by the license management server 200.

The device 100 transmits a request for a license usage status to the license management server 200 (Step S80). The license management server 200 refers to the HDD 210 to obtain a purchased formal-version license count, a rented-out formal-license count, and a rented-out trial-version license count (Step S81). The license management server 200 notifies the device 100 of the purchased formal-version license count, the rented-out formal-license count, and the rented-out trial-version license count (Step S82). The device 100 creates a line graph charting the license usage status based on the purchased formal-version license count, the rented-out formal-license count, and the rented-out trial-version license count received from the license management server 200 and displays the line graph on the operation display unit 190 (Step S83).

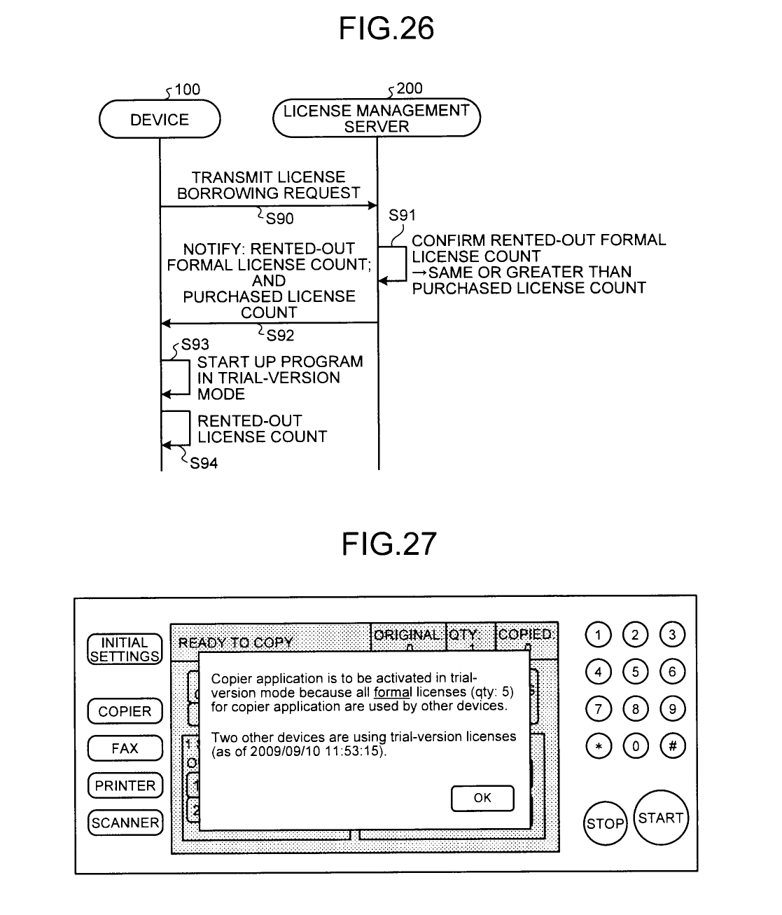

A procedure for displaying, by the license management server 200, a screen (hereinafter, “rented-out-trial-version-license-count presentation screen”) that presents a rented-out trial-version-license count will be described below. FIG. 26 is a sequence diagram illustrating a procedure for a process, to be performed by the license management server 200, of displaying the rented-out-trial-version-license-count presentation screen.

The device 100 transmits a license borrowing request to the license management server 200 (Step S90). The license management server 200 confirms a rented-out formal-license count and determines that it is impossible to rent out a formal-version license any more (Step S91). The license management server 200 rents out a trial-version license to the device 100 and notifies the device 100 of a purchased formal-version license count and a rented-out trial-version license count (Step S92). The license management server 200 may notify the device 100 that the program is to be enabled under a trial-version license. The device 100 starts up the program in the trial-version mode (Step S93). The device 100 displays the purchased formal-version license count and the rented-out trial-version license count on the operation display unit 190 (Step S94).

A specific example of a screen (hereinafter, “trial-version license rent-out notification screen”) that notifies that the license management server 200 rents out a trial-version license to the device 100 when the license management server 200 is impossible to rent out the formal-version license will be described below. FIG. 27 is a diagram illustrating an example of the trial-version license rent-out notification screen. As illustrated at Step S94 in the sequence diagram illustrated in FIG. 26, immediately after starting up a program in the trial-version mode, the display control unit 134 displays a screen indicating that the program has been started in the trial-version mode on the LCD. FIG. 27 illustrates an example where the display control unit 134 displays that the copier application is started up in the trial-version mode because all of five formal-version licenses for the copier application are used by other devices. The display control unit 134 also displays, as reference information, indication that two other devices are using the copier application under trial-version licenses. This allows a user to recognize how formal-version licenses are insufficient in quantity.

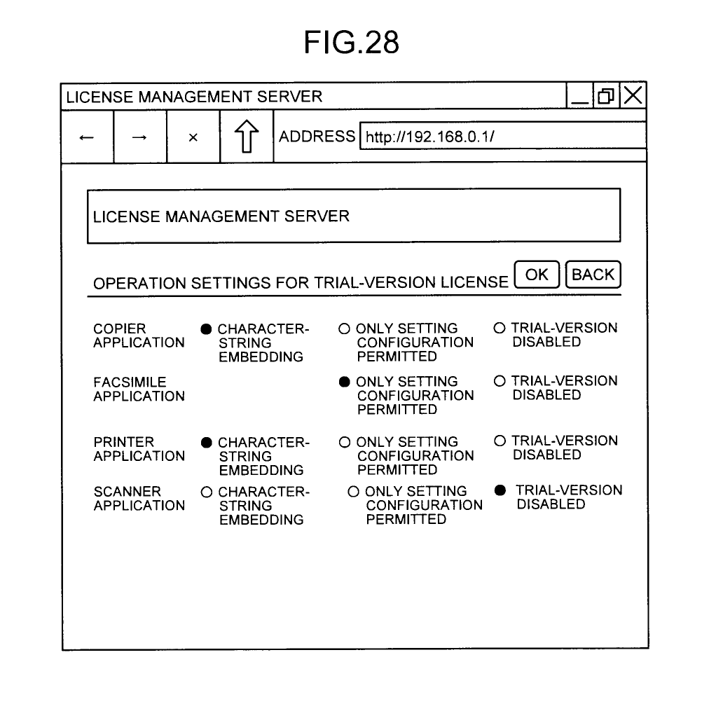

A specific example of an operation setting screen for a program enabled under a trial-version license will be described below. FIG. 28 is a schematic diagram illustrating an example of the operation setting screen for a trial-version license. As described above with reference to FIG. 17, it is allowed to configure operation settings based on program types. With reference to FIG. 28, the display control unit 134 displays three types (modes) of operations of program enabled under a trial-version license. The three modes are, more specifically, a “CHARACTER-STRING EMBEDDING” mode where a character string, such as “TRIAL VERSION” is embedded in an output, such as a printout, an “ONLY SETTING CONFIGURATION PERMITTED” mode where running a job is inhibited but setting configuration immediately preceding the running of the job is allowed, and a “TRIAL-VERSION DISABLED” mode where all operations are inhibited.

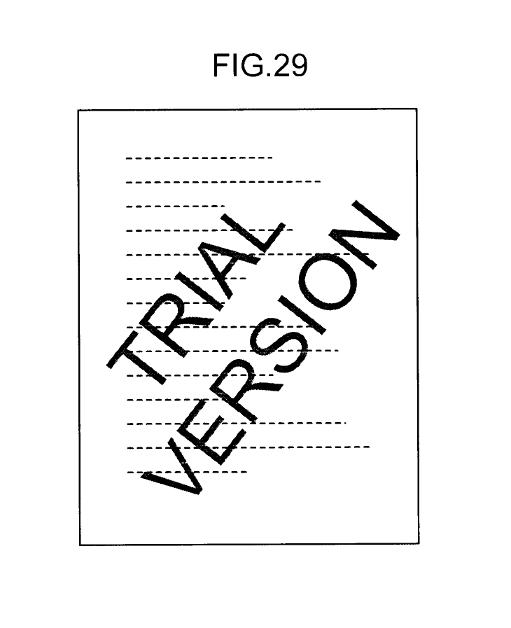

An example of a document output in the “CHARACTER-STRING EMBEDDING” mode will be described below. FIG. 29 is an example of a document output in the “CHARACTER-STRING EMBEDDING” mode. As illustrated in FIG. 29, the display control unit 134 embeds a character string “TRIAL VERSION” in the document. Although a user cannot use the document, in which the character string “TRIAL VERSION” is embedded, for an originally-intended purpose, the user can experience an operation and printout.

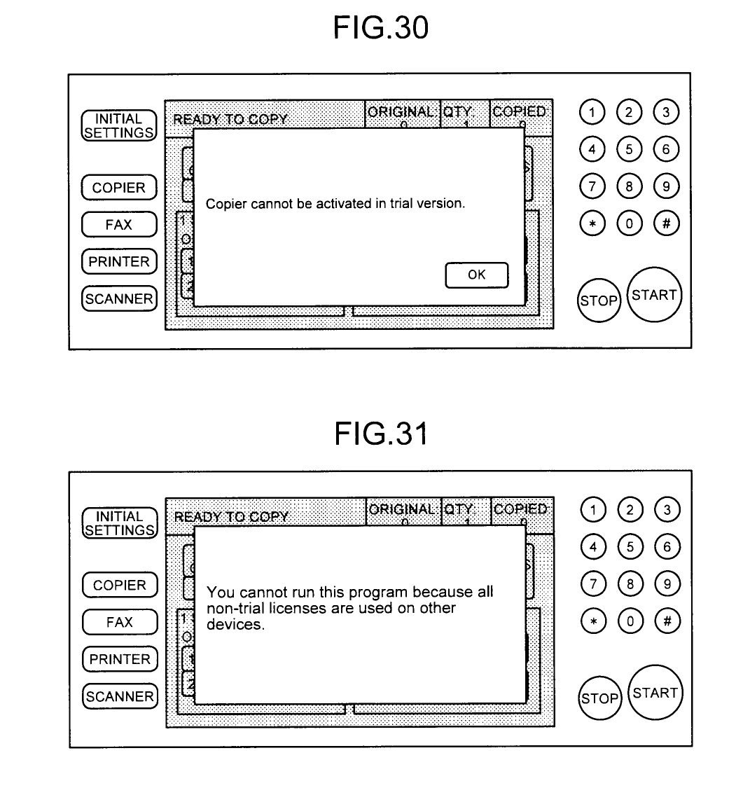

The “ONLY SETTING CONFIGURATION PERMITTED” mode is to be used in a situation where even a character string, such as “TRIAL VERSION” is embedded in a document, external transmission of the document, in which the character string is embedded, is completely inhibited. For instance, facsimile transmission of the document is inhibited. An error notification screen that is to appear when an attempt of using the copier application in the “ONLY SETTING CONFIGURATION PERMITTED” mode is made will be described below. FIG. 30 is a diagram illustrating an example of the error notification screen that is to appear in the “ONLY SETTING CONFIGURATION PERMITTED” mode. As described above with reference to FIG. 28, when the “START” key is pressed after the setting configuration of selecting the “ONLY SETTING CONFIGURATION PERMITTED” mode is performed on a screen for the copier application, running a job in this mode is disabled. Accordingly, the display control unit 134 displays, on the operation display unit 190, a warning screen indicating that the copier cannot be activated. Meanwhile, when the “OK” button is pressed by a user on the warning screen, the setting configuration screen having been displayed before the “START” key is pressed appears again.

In FIG. 28, the display control unit 134 displays such that the “CHARACTER-STRING EMBEDDING” mode cannot be set in the facsimile application. The “TRIAL-VERSION DISABLED” mode is to be used to inhibit configuration setting itself; for instance, this mode is used for such a program providing only operations that are so simple that trying out the operations is meaningless. An error notification screen that is to appear when an attempt of starting the copier application in the “TRIAL-VERSION DISABLED” mode is made will be described below. FIG. 31 is a diagram illustrating an example of the error notification screen that is to appear when an attempt of starting the copier application is made in the “TRIAL-VERSION DISABLED” mode. Upon detecting that the “COPIER” key is pressed to start the copier application, the device 100 obtains a trial-version license from the license management server 200 when the license management server 200 has no available formal-version license. However, if the “TRIAL-VERSION DISABLED” mode has been set in this case, running the program is completely disabled. Accordingly, the display control unit 134 displays a warning screen indicating that the program cannot be run as illustrated in FIG. 31. In this case, the display control unit 134 does not display an “OK” button or the like because there is no other choice.

As described above, according to the present embodiment, a user may determine whether to additionally purchase a formal-version license for a program according to a usage status indicating how the program is used by devices.

The license management server 200 according to the present embodiment has hardware configuration that utilizes a typical computer and includes a control device such as a CPU, a storage device such as a ROM (Read ony memory) and/or a RAM (Random Access Memory), an external storage device such as an HDD and/or a CD drive, a display device, and an input device such as a keyboard and/or a mouse.

A license management program to be executed by the license management server 200 according to the present embodiment may be provided as being recorded in a computer-readable recording medium such as a compact disc-read-only memory (CD-ROM), a flexible disk (FD), a CD recordable (CD-R), or a digital versatile disk (DVD) in files that are installable or executable formats.

The license management program to be executed by the license management server 200 according to the present embodiment may be stored in a computer connected to a network, such as the Internet, so that the program is provided by downloading via the network. The license management program to be executed by the license management server 200 according to the embodiment may be provided or distributed via a network, such as the Internet.

The license management program according to the embodiment may be configured to be provided as being installed in a ROM or the like in advance.

The license management program to be executed by the license management server 200 according to the embodiment has a module structure that includes the units (the rent-out control unit, the obtaining unit, and the notification unit) described above. From the viewpoint of actual hardware, the CPU (processor) reads the license management program from the storage medium and executes the program to load the units on a main memory device, thereby generating the rent-out control unit, the obtaining unit, and the notification unit on the main memory device.

According to an aspect of the present invention, a user is advantageously allowed to determine whether to additionally purchase a formal-version license for a program according to a usage status indicating how the program is used by devices.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A license management system comprising:
a plurality of image processing apparatuses; and
a license management server that rents out a license to the image processing apparatuses, wherein
the license management server includes:
a storage unit that stores a purchased license count, which is number of licenses purchased by a user, and a rented-out license count, which is number of licenses rented out to the image processing apparatuses, the purchased license count and the rented-out license count being associated with type of a program;
a first receiving unit that receives a license borrowing request from an image processing apparatus of the plurality of image processing apparatuses;
a rent-out control unit that, upon receiving the request, accesses the storage unit to determine whether the rented-out license count is equal to or greater than the purchased license count, and, if the rented-out license count is determined to be equal to or greater than the purchased license count, determines to rent out a trial-version license as the license whereas, if the rented-out license count is determined to be less than the purchased license count, determines to rent out a formal-version license as the license, the trial-version license imposing limitation on some of functions of the program, the formal-version license enabling all the functions of the program;
a first transmitting unit that transmits the license determined by the rent-out control unit to the image processing apparatus;
an obtaining unit that obtains usage status indicating how the image processing processes use the formal-version licenses and the trial-version licenses; and
a first notification unit that notifies the user of the usage status obtained by the obtaining unit, and
the image processing apparatus includes:
a second transmitting unit that transmits the request;
a second receiving unit that receives the license determined by the rent-out control unit; and
a starting control unit that determines an operating mode depending on a type of the license received by the second receiving unit and starts up the program in the determined operating mode.

2. The license management system according to claim 1, wherein
the storage unit stores the rented-out license count such that the rented-out license count is categorized, in terms of license type, into rented-out license counts, each of which is further associated with a type of program,
the obtaining unit obtains, as the usages status, the rented-out license counts based on the types of license at predetermined time intervals, and
the first notification unit notifies the user of the usage status obtained by the obtaining unit.

3. The license management system according to claim 1, wherein the first notification unit displays the usage status on a display unit of the license management server.

4. The license management system according to claim 1, wherein the first notification unit displays the usage status on a display unit of the one image processing apparatus.

5. The license management system according to claim 1, wherein the first notification unit transmits an electronic mail to the image processing apparatus concerning the usage status.

6. The license management system according to claim 1, wherein if the license received by the second receiving unit is the formal-version license, the starting control unit starts up the program in a normal mode that enables all functions provided by the program whereas, if the license is the trial-version license, the starting control unit starts up the program in a trial-version mode that imposes limitation on some of the functions provided by the program.

7. The license management system according to claim 1, wherein
when the rent-out control unit determines to rent out the trial-version license, the first notification notifies the one image processing apparatus of the purchased formal-version license count, the rented-out formal-version license count, and a rented-out trial-version license count, and
the image processing apparatus further includes a second notification unit that notifies the user of the purchased formal-version license count, the rented-out formal-version license count, and the rented-out trial-version license count.

8. A license management method to be performed by a license management system that includes an image processing apparatus and a license management server that rents out licenses to the image processing apparatus, the license management method comprising:
storing a purchased license count, which is number of licenses purchased by a user, and a rented-out license count, which is number of licenses rented out to the image processing apparatus, the purchased license count and the rented-out license count being associated with type of a program;
receiving, as first receipt, a license borrowing request from one image processing apparatus of the image processing apparatuses;
performing, on receiving the request, rent-out control by accessing the storage unit to determine whether the rented-out license count is equal to or greater than the purchased license count, and, if the rented-out license count is determined to be equal to or greater than the purchased license count, determining to rent out a trial-version license as the license whereas, if the rented-out license count is determined to be less than the purchased license count, determining to rent out a formal-version license as the license, the trial-version license imposing limitation on some of functions of the program, the formal-version license enabling all the functions of the program;
transmitting, as first transmission, the license determined at the rent-out control to the one image processing apparatus;
obtaining usage status indicating how the image processing processes use the formal-version licenses and the trial-version licenses;
notifying, as first notification, the user of the usage status;
transmitting, as second transmission, the request;
receiving, as second receipt, the license determined at the rent-out control; and
performing starting control by determining an operating mode depending on a type of the license received at the second receipt and starting up the program in the operating mode, the operating mode designating an operating condition of the program, wherein
the storing, the first receipt, the rent-out control, the first transmission, the obtaining, and the first notification are performed by the license management server, and
the second transmission, the second receipt, and the starting control are performed by the one image processing apparatus.

9. A computer program product comprising a computer readable medium having computer readable program instructions that, when executed on a computer connected to image processing apparatus and to a license management server that rents out licenses to the image processing apparatuses, cause the computer to execute:
storing a purchased license count, which is number of licenses purchased by a user, and a rented-out license count, which is number of licenses rented out to the image processing apparatuses, the purchased license count and the rented-out license count being associated with type of a program;
receiving, as first receipt, a license borrowing request from one image processing apparatus of the image processing apparatuses;
performing, on receiving the request, rent-out control by accessing the storage unit to determine whether the rented-out license count is equal to or greater than the purchased license count, and, if the rented-out license count is determined to be equal to or greater than the purchased license count, determining to rent out a trial-version license as the license whereas, if the rented-out license count is determined to be smaller than the purchased license count, determining to rent out a formal-version license as the license, the trial-version license imposing limitation on some of functions of the program, the formal-version license enabling all the functions of the program;
transmitting, as first transmission, the license determined at the rent-out control to the one image processing apparatus;
obtaining usage status indicating how the image processing processes use the formal-version licenses and the trial-version licenses;
notifying, as first notification, the user of the usage status;
transmitting, as second transmission, the request;
receiving, as second receipt, the license determined at the rent-out control; and
performing starting control by determining an operating mode depending on a type of the license received at the second receipt and starting up the program in the operating mode, the operating mode designating an operating condition of the program, wherein
the storing, the first receipt, the rent-out control, the first transmission, the obtaining, and the first notification are performed by the license management server, and
the second transmission, the second receipt, and the starting control are performed by the one image processing apparatus.
